(19) United States
(12) Patent Application Publication
(10) Pub. No.: US 2026/0350611 A1
(43) Pub. Date: Nov. 5, 2026

(54) Sealed API Gateways and Execution Enforcement for Third-Party Platform Integration

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/335,899

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.

(51) Int. Cl. G06Q 20/40; G06F 9/54; G06Q 20/02

(52) U.S. Cl. CPC G06Q 20/401; G06F 9/547; G06Q 20/027

(57) ABSTRACT

A sealed API gateway system that verifies third-party platform requests before allowing commercial execution. The system uses metadata, licensing tokens, and trust thresholds to filter and control access to sealed fulfillment rails. Unauthorized requests are denied, logged, and prevented from triggering execution.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates generally to digital transaction platforms and, more particularly, to sealed execution systems that regulate and enforce API-based integration from third-party platforms.

### BACKGROUND OF THE INVENTION

Modern commerce platforms frequently expose APIs to enable third-party service access, but lack security controls to verify execution paths or trust mechanisms.

Unauthorized services or tools may exploit these open APIs, reroute buyer activity, or bypass fulfillment protections.

There is a need for a sealed execution gateway that accepts only verified API connections, enforces licensing, and denies unauthorized execution flows.

### SUMMARY OF THE INVENTION

This invention provides a sealed API integration layer that acts as a gateway to all third-party requests, requiring pre-verification and licensing before any execution can occur.

Third-party platforms are required to route requests through licensed API endpoints tied to the execution rail logic.

Execution is denied unless the request passes licensing, metadata verification, and trust enforcement protocols.

API calls are recorded, audited, and routed through escrow and vendor-verification modules before fulfillment is authorized.

### DETAILED DESCRIPTION OF THE INVENTION

The system comprises a sealed API gateway that only permits inbound requests from whitelisted or pre-approved third-party entities.

All inbound requests must include metadata tokens indicating platform identity, licensing ID, session trace, and escrow status.

The API gateway verifies the authenticity of the request, including trust tier, vendor legitimacy, and jurisdictional permissions.

Approved API calls are passed into the platform's execution engine, where escrow, compliance filters, and sealed fulfillment logic are applied.

Unauthorized calls are rejected, logged, and flagged for enforcement action, with records stored for audit trails.

API-level execution requires explicit platform-issued tokens per function, tied to usage conditions and regional trust tiers.

The invention ensures that external platforms cannot fulfill or process buyer or seller activity without operating within the sealed execution rail.

All API requests are embedded with time-lock features, expiring if verification or execution is not complete within a secure time window.

Vendors accessing the API must register through a licensing portal and undergo trust scoring and contract review.

The API can optionally disable or throttle access during compliance drift or unverified request surges.

What is claimed is:

1. A sealed API gateway comprising:
an inbound request verifier;
a licensing token validator;
and an execution rail controller that blocks unauthorized fulfillment.

2. The system of claim 1, wherein all requests must include metadata tokens tied to license ID, platform origin, session token, and escrow status.

3. The system of claim 1, wherein execution is denied if license status is revoked or token is missing.

4. A method comprising:
receiving an API request from a third-party platform;
validating metadata; checking licensing status;
and triggering execution only if compliant.

5. The system of claim 1, further comprising a trust-scoring engine that ranks third-party entities before access is granted.

6. The method of claim 4, wherein API tokens include expiration timestamps and geolocation locks.

7. The system of claim 1, wherein rejected requests are recorded in an audit ledger.

8. A compliance enforcement module comprising:
API throttling, usage tracking, and region-based permission gates.

9. The system of claim 1, wherein external platforms are denied access to commercial execution unless licensed.

10. A method comprising:
registering vendors to receive API credentials;
enforcing contract-based usage policies;
and gating execution through escrow.

11. The system of claim 1, wherein execution requires real-time metadata comparison to detect tampering or expired access.

12. A method comprising:
embedding escrow requirements into API execution calls;
rejecting any call that fails validation.

13. The system of claim 1, wherein compliance filters screen each request against jurisdictional rules and vendor status.

14. The system of claim 1, wherein metadata includes session trace, platform ID, and vendor authorization token.

15. A system for monitoring API activity comprising:
timestamped logs, violation triggers, and trust decay scoring.

16. A licensing control mechanism comprising:
API-level token issuance, usage terms, and revocation tracking.

17. The method of claim 4, wherein non-compliant APIs are dynamically blacklisted from further access.

18. A sealed execution path activated only when API metadata passes trust and license thresholds.

19. A method comprising:
onboarding API partners through a verification portal;
issuing dynamic access keys; and enforcing sealed execution policy.

20. A platform-integrated API governance system comprising:
inbound validation, metadata scoring, escrow enforcement, and fulfillment denial for unverified calls.

21. The system of claim 1, wherein visual recognition data is cross-verified with input metadata before execution authorization is granted.
